(19) United States
(12) Patent Application Publication
(10) Pub. No.: US 2007/0082971 A1
(43) Pub. Date: Apr. 12, 2007

(54) Use of a plastic composition and a product obtained thereby

(75) Inventor: Luigi Mocchia, Trino (IT)

Correspondence Address: STEVENS DAVIS MILLER & MOSHER, LLP, 1615 L STREET, NW, SUITE 850, WASHINGTON, DC, 20036, US

(73) Assignee: POLYGIENE AB, Malmo (SE)

(21) Appl. No.: 10/585,862

(22) PCT Filed: Jan. 27, 2005
(86) PCT No.: PCT/SE05/00089

§ 371 Date: Jul. 11, 2006

(30) Foreign Application Priority Data
Feb. 23, 2004 (SE) 0400409-9

(51) Int. Cl. C09D 5/16

(52) U.S. Cl. 523/122

(57) ABSTRACT

Use of a plastic composition comprising an effective amount of an inorganic derivative containing silver, including silver salts and silver containing complexes for preparation of molded products respectively lacquered or painted products to provide them with a surface having antivirus activity even against SARS coronavirus and a product obtained thereby.

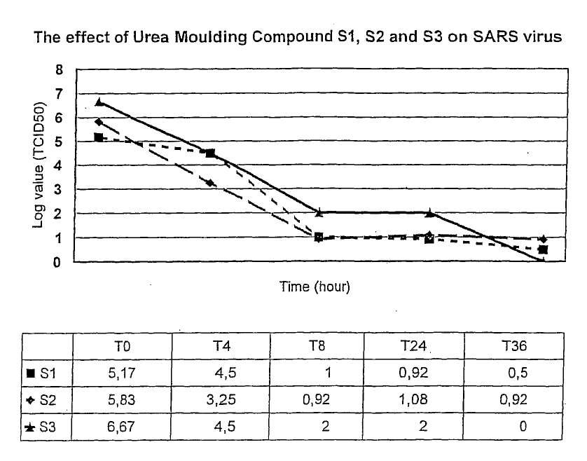

The present invention relates to a use of a plastic composition comprising an inorganic derivative containing silver, including silver salts and silver containing complexes in an effective amount to give an antivirus effect. In addition the invention relates to product obtained at the use of the composition.

There is a great need for a plastic (polymer) composition which can be used for the production of articles having at least a surface with antivirus effect. This is especially true for such products having an antivirus effect on very dangerous viruses like SARS coronavirus.

WO 01/79349 discloses urea moulding compounds based on cellulose and urea/formaldehyde resin containing an antiseptic agent which can consist of silver-sodium-zirconium phosphate for instance. The urea moulding compounds of above publication are solely shown to give some antibacterial effect. However, no antivirus effect is mentioned therein and could not be expected either, since it is well-known that a bacteria and a virus are usually combatted in totally different ways.

The need for plastic (polymer) compositions having such an antivirus effect is especially great for products which many different people come into contact with in a short tire. In such cases the risk of a virus epidemic is very high.

By the present invention the above need has been met.

According to one embodiment of the invention the plastic in the composition is a thermo-setting resin, preferably an amino resin such as urea-formaldehyde resin, melamine-formaldehyde resin, melamine-urea-formaldehyde resin or a polyester. In said case the plastic composition is often a moulding compound advantageously present in the form of powder, tablets, pellets or granules, usually called moulding powder. Amino resins and polyester resins are well-known in the art. Therefore a more detailed disclosure of the production thereof should not be necessary. In summary urea moulding compounds as an example of an amino moulding compound are traditionally obtained by preparing a urea formaldehyde resin in the presence of cellulose, than subjecting the resulting product to drying, milling and optional addition of pigments, lubricants or other suitable excipients, depending on the intended applications. The urea resin is usually prepared in the presence of catalysts such as zinc salts.

The resulting product, in the form of powders or granules, etc as mentioned above can then be subjected to moulding with conventional techniques, for example by transfer, injection or compression, to obtain a wide variety of articles, such as sanitary articles, kitchenware, tableware, ornamental articles, electrotechnology components and the like.

Sanitary articles such as toilet seats and lids are at present one of the most important application fields for urea moulding compounds.

Other fillers than cellulose, such as glass fiber, carbon fiber, mica, lime and wood flour can be present in the moulding compound.

It might be advantageous according to the invention that the plastic composition contains free formaldehyde or a formaldehyde containing compound which can release formaldehyde from the surface of the article produced since formaldehyde as such or in combination with the silver containing compound seems to contribute to the antivirus activity of the plastic composition.

It might be possible to add a surplus of formaldehyde at any production step of the production of an amino moulding compound to get a content of free unreacted, releasable formaldehyde in the compound.

However, the addition of the surplus of formaldehyde is preferably carried out at a late stage of the production namely at the ball milling or coluring step to ensure that a uniform distribution of the formaldehyde is obtained and that the formaldehyde will not react with the amino compound such as urea. The formaldehyde can preferably be added as paraformaldehyde.

The inorganic derivative containing silver can be added at any step of the production of the amino moulding compound but to get an even distribution thereof in the moulding compound it is preferred to add it also in the above mentioned ball milling or colouring step.

According to another embodiment of the invention the thermosetting resin of the plastic composition can be present in dry form as a constituent in a powder coatings or in liquid form, usually as a lacquer or paint, such as maleimide lacquer, melamine-formaldehyde resin, urea-formaldehyde resin or melamine-urea-formaldehyde resin.

The liquid thermosetting resin can advantageously by used for impregnating paper sheets which are well-known in the production of thermosetting laminates. Then one or more such impregnated sheets including a decor sheet are laminated together or bonded to a core for instance of particle board or fiber board. Such decorative laminates are used frequently for table tops, wall covering and flooring products.

Of course the liquid thermosetting resins can be used for providing various surfaces with a coating by any conventional method.

The inorganic derivative containing silver is preferably selected from the group consisting of silver sulfate, silver nitrate, silver chloride, silver-sodium-hydrogen-zirconium phosphate and silver sulfadiazine. However, also other silver containing compounds can be used. When the plastic composition is used in liquid form the above silver compound is suitably mixed with the finished liquid composition.

According to another embodiment of the invention the plastic of the plastic composition may be a thermoplastic, preferably polyethylene, polypropylene, polystyrene, polyvinyl chloride or a linear polyester or a polyacrylate.

This thermoplastic composition may be present as a so-called masterbatch in the form of pellets granules or tablets. In this masterbatch mainly consisting of thermoplastic the content of inorganic silver derivative is preferably 0.02 to 0.30 parts by weight per part by weight of the whole mastierbatch. The masterbatch might have a high content of pigment also and is intended to be mixed as a minor part with the major part of the virgin thermoplastic before any moulding. Even in a thermoplastic composition it might be favourable to have a content of a formaldehyde containing compound which can result in a finished product releasing formaldehyde.

The thermoplastic composition could also be used in liquid form where the thermoplastic might be selected from a linear polyester or a polyacrylate. The composition is in that case mainly used as a lacquer or paint for surface coating of products of wood, metal etc.

The thermoplastic composition can also be present as a foil or sheet and used as a surface coating of products mentioned above.

In all plastic compositions above except for the thermoplastic masterbatch, the composition advantageously has a content of inorganic silver derivative in an amount of 0.00001 to 0.10 parts by weight, preferably 0.00003 to 0.001 parts by weight or rather 0.00005 to 0.0008 parts by weight calculated per part by weight of the whole composition. However, the content of silver compound may be much higher such, as up to 2% or up to 1%.

The plastic composition according to the present invention has shown a very good but highly unexpected antivirus activity even against SARS coronavirus which is a very aggressive virus that has already caused the death of many people. Of course the present invention may be extremely important for the fight against SARS coronavirus but also other less dangerous virus.

The present invention is explained further in connection with the embodiment examples below and the enclosed drawing. Example 1 shows a production of a urea-formaldehyde moulding compound according to one embodiment of the invention containing 300 ppm silver sulfate. In Example 2, the same process for the production of a urea-formaldehyde-moulding compound as in Example 1 was used but then 200 ppm silver sulfate and 0.3% paraformaldehyde were added instead of 300 ppm silver sulfate. In Example 3 also the procedure of Example 1 was repeated but here 50 ppm of silver sulfate and 0.3% paraform-aldehyde were added instead of 300 ppm silver sulfate.

In Example 4 the effect of the urea-formaldehyde moulding compounds from Examples 1-3 on SARS coronavirus was tested and in the enclosed drawing the calculated TCID 50 value of the products from Examples 1-3 is illustrated as curves after 0, 4, 8, 24 and 36 hours.

### EXAMPLE 1

49.6 kg of formurea type F630 was intimately mixed with 16.6 kg of 36% formaldehyde, and 1.6 kg of 32% hexamine solution during 1 h at room temperature. The resulting clear solution was in its turn mixed together with 48.8 kg of 70% urea solution for 1 h. The resulting syrup was first cooled to 20° C. and then left to stand at said temperature for about one hour. The thus treated syrup was combined with 30 kg of α cellulose cut into small pieces, 0.3 kg of zinc stearate, and zinc sulphate (sufficient to adjust the final pH to 7.3) in 1 h. The mix was continuously mixed for 2 h at a temperature of 45° C. to obtain a homogeneous but friable mass weighing about 147 kg, which was loaded as a thin layer on a rotary drier in 1 h. The hot air drying step lasted about 2 h to obtain a final yield of about 100 kg of dry crumb. The resulting 100 kg of crumb were milled in a pulverizer mill with cold air flow to remove the product while preventing it from overheating. Air from the mill and containing the powdery product with particle size distribution ranging from 20μ to 120μ was filtered through bag filters; the separated product was pneumatically conveyed to a 400 l ball mill containing 250 kg of porcelain balls. In addition to the 100 kg of base, the ball mill was loaded with 0.8 kg of zinc stearate, 0.1 kg of o, p-Toluenesulfonamide, 0.8 kg of Titanium dioxide and 3 g silver sulfate. The mass was rotated at 20 revolutions/min for 4 h keeping the inner temperature below 60° C. At the end of the operation, 102.7 kg of white powder were obtained which were poured into a 400 l ribbon mixer before being dry granulated.

The powder was compacted in about 40 minutes through a single screw extruder thermo-statized at 80° C., keeping the screw at 52 revolutions/min and the absorbed power at 36 KW/h. The extruded chop was cooled to 30° C. with air in a vibratory unit and was then ground in a grinding mill rotating at 270 revolutions/min and sieved to the desired particle size distribution (0.2 mm to 1.2 mm) through a vibrating sieve. During sieving, in addition to the desired particle size fraction two further fractions are obtained; one with size larger than 1.2 mm and one with size smaller than 0.2 mm. The first one was remilled while the second was removed.

The final yield was 80 kg of finished, packed product, called S1.

### EXAMPLE 2

The embodiment of Example 1 was repeated with the difference that 2 g silver sulfate and 300 g parafformaldehyde were added instead of 3 g silver sulfate. The final product was called S2.

### EXAMPLE 3

The embodiment of Example 1 was repeated with the difference that 0.5 g silver suflate and 300 g paraformaldehyde were added instead of 3 g silver sulfate. The final product was called S3.

### EXAMPLE 4

Test sample wells were moulded of each of the moulding compounds S1, (Example 1 above) S2, (Example 2 above) and S3 (Example 3 above). The samples had a size of 1.5×1.5 cm.

The antiviral activity of these samples S1, S2 and S3 was tested by the Military Academy of Medical Science, Beijing, China.

The invitro antiviral activity was tested in Vero E6 cell line infected with SARS coronavirus (BJ01), which is highly pathogenic to human being.

SARS coronavirus (SARS-CoV) BJ01 was supplied by Beijing Institute of Microbiology and Epidemiology.

The cultures of virus strain in Vero E6 and Vero cell line were prepared for the experiment as follows.

100 μl culture (the virus titer expressed as TCID50=LOG 7.0) were daubed on to the surface of each well of S1, S2 and S3 (1.5×1.5 cm) separately. The samples were left at the room temperature (about 20-25° C.) and checked at 0 h, 4 h, 8 h, 24 h and 36 h respectively.

At 0 h, 4 h, 8 h, 24 h and 36 h, calibrated aliquot of suspension was collected to check survived virus. Each sample was diluted from 10⁻¹ to 10⁻⁷, and inoculated in 4 culture wells and cultured at 37° C. (contain 5% CO₂). CPE (cell pathogenic effect) was continually observied and the TCID50 was calculated.

In the samples of S1 and S2, alive SARS-CoV couldn't be detected after 36 hours (<1% alive SARS-CoV) and in the sample of S3 alive SARS-CoV couldn't be detected already after 24 hours.

The calculated TCID50 values after 0 h (T0), 4 h (T4), 8 h (T8), 24 h (T24) and 36 h (T36) for the production S1, S2 and S3 are illustrated on the enclosed drawing. The values of virus are expressed as log values of TCID50.

1.-16. (canceled)

17. A method for providing a molded lacquered or painted product with a surface having antivirus activity even against SARS coroavirus, wherein a plastic composition comprising an effective amount of an inorganic derivative containing silver, including silver salts and silver containing complexes is used.

18. The method according to claim 17, wherein the plastic of the plastic composition is a thermosetting resin.

19. The method according to claim 18, wherein the thermosetting resin is an amino resin selected from the group consisting of urea-formaldehyde resin, melamine-formaldehyde resin, melamine-urea-formaldehyde resin or a polyester.

20. The method according to claim 18, wherein the plastic composition is present as a solid molding compound in the form of powder, tables, pellets or granules.

21. The method according to claim 18, wherein the plastic composition is present as a dry constituent in a powder coating.

22. The method according to claim 18, wherein the composition contains free formaldehyde or a formaldehyde containing compound which can release formaldehyde.

23. The method according to claim 17, wherein the plastic composition comprises at least one filler selected from the group consisting of cellulose, glass fiber, carbon fiber, mica, lime and wood floor.

24. The method according to claim 18, wherein the thermosetting resin is present in liquid form, usually as a lacquer or paint comprising maleimide lacquer, melamine-formaldehyde resin, urea-formaldehyde resin or melamine-urea-formaldehyde resin.

25. The method according to claim 17, wherein the inorganic derivative containing silver is selected from the group consisting of silver sulphate, silver nitrate, silver chloride, silver-sodium-hydrogen-zirconium phosphate and silver sulfadiazine.

26. The method according to claim 17, wherein the plastic is a thermoplastic comprising polyethylene, polypropylene, polystyrene, polyvinyl chloride, a linear polyester and a polyacrylate.

27. The method according to claim 26, wherein the thermoplastic is present as a foil or a sheet.

28. The method according to claim 26, wherein the plastic composition is present as a so-called masterbatch in the form of pellets, granules or tablets having a content of inorganic silver derivative of 0.02 to 0.30 parts by weight per part by weight of the whole masterbatch, which masterbatch might have a high content of pigment also and intended to be mixed with a major part of the thermoplastic before any molding.

29. The method according to claim 26, wherein the thermoplastic is a polyacrylate or a linear polyester in liquid form as a lacquer or a paint.

30. The method according to claim 17, wherein the content of inorganic silver derivative is present in an amount of 0.00001 to 0.10 parts by weight, preferably 0.00003 to 0.001 parts by weight or, rather 0.00005 to 0.00008 parts by weight calculated per part by weight of the whole composition.

31. The method according to claim 17, wherein the molded products comprise sanitary articles, kitchen ware, table ware, ornamental articles, electrotechnology components and thermosetting laminates.

32. The molded, lacquered or painted product having a surface with antivirus activity even against SARS coronavirus obtained by the method of claim 17.
